(19) United States
(12) Patent Application Publication
(10) Pub. No.: US 2004/0033469 A1
(43) Pub. Date: Feb. 19, 2004

(54) Dental implant anchor having internal/external wrench engaging means

(76) Inventor: Gordon D. Blacklock, Albuquerque, NM (US)

Correspondence Address: Sonya C. Harris, PO Box 2607, Fairfax, VA, 22031, US

(21) Appl. No.: 10/218,599

(22) Filed: Aug. 15, 2002

(51) Int. Cl. A61C 8/00

(52) U.S. Cl. 433/173

(57) ABSTRACT

A screw type dental implant anchor having external, helical threads (bone engaging ridges) for engaging bony tissue of a patient' mouth. The body may have a smooth section at its upper end or be threaded along its full length. A threaded, internal cavity for securing a post and core assembly may have substantially cylindrical walls, be tapered along its length, or transition from tapered proximate it opened end to substantially conical proximate its depth. Unique slots passing though a raised area of the body of the implant and into the internal cavity provide both internal and external wrenching capability for installing the implant, as well as added anti-rotational support for the abutment of the prosthesis. The internal/external slots provide enhanced strength for wrenching and eases installation in less accessible locations, as well as providing additional venting of excess cement, thereby preventing hydraulic lock.

### BACKGROUND OF THE INVENTION

1. Field of the Invention

The present invention relates to an anchor which is inserted into a bone for the purpose of receiving a post and core. The anchor threads to bone tissue, and provides structure for secure mounting of the post and core within the mouth. Enhanced internal and external wrenching surfaces allow for easier and stronger installation of the anchor into the bone tissue as well as providing additional anti-rotational surfaces for abutments.

2. Description of the Prior Art

Replacement or artificial teeth have become available as an answer to the loss of original teeth. Natural or original teeth are secured in place by roots, which cooperate with the body tissue. When a natural or original tooth is lost, the root is usually also lost. Secure attachment for the new tooth must be provided which will hold and support the tooth securely enough to resist forces generated in biting and chewing.

In contemporary practice, an implant anchor with a socket or receptacle for receiving a post and core abutment is placed in the bony tissue of the jaw, and a post and core abutment assembly is set into the receptacle. The receptacle must cooperate with the abutment which is set into it. Usually, underlying bone tissue is drilled to accept an anchor. The anchor is threaded into the bone, frequently serving as its own tap to form threads in the bone.

The receptacle normally secures the post and core in one of two ways. For removable securement, the post is threaded into the receptacle. For permanent securement, the shank of the post frictionally engages a cooperating bore formed in the anchor, and the engagement is reinforced by cementing the post in place.

Normally, the anchor is provided with self-tapping threads, and engages the bone by being screwed into a hole bored into the bone. The self-tapping threads carve cooperating threads into the unthreaded hole in the bone. In some prior art threading schemes, the final diameter of the threads formed in the bone is achieved by the first convolutions of the self-tapping threads of the anchor.

A number of differing anchor designs have been set forth in the past, typically utilizing an internal thread and anti-rotational cavity or internal threads and external wrenching to aid in wrenching the implant into the bony tissue, including:

U.S. Pat. No. 4,960,381, issued to Gerald A. Niznick on Oct. 2, 1990 presents a SCREW-TYPE DENTAL IMPLANT ANCHOR having a body with external threads for engaging bony tissue and an internal wrenching surface for cooperating with a wrenching device, such as an allen type wrench and also with an internal abutment. By contrast, the present invention has an internal/external wrenching surface which may cooperate with a wrenching device and an internal or external prosthetic abutment to provide anti-rotational hold.

U.S. Pat. No. 4,863,383, issued to Hans L. Grafelmann on Sep. 5, 1989, illustrates an implant having an anchor which has a tapered body. Unlike the present invention, the screw threads are of constant outer diameter throughout the length of the anchor. This is in contrast to the present invention, wherein threads are of progressively increasing outer diameter. Grafelmann also provides the upper end of his anchor with an opening for receiving a post, which opening has both a hexagonal portion and also female threading. The threading is located below the hexagonal portion.

U.S. Pat. No. 5,078,607, issued to Gerald A. Niznick on Jan. 7, 1992; U.S. Pat. No. 5,246,369, issued to Francis Poulmaire on Sep. 21, 1993; and U.S. Pat. No. 5,312,256, issued to Gerard Scortecci on May 17, 1994, further illustrate anchored dental implants. In all cases, external threading engaging bone tissue is of constant diameter, unlike that of the present invention. Also unlike the present invention, only an internally engaging wrenching device is provided for.

None of the above inventions and patents, taken either singly or in combination, is seen to describe the instant invention as claimed.

### SUMMARY OF THE INVENTION

In the field of dental implant anchors, there has always been a need for implants having strong wrench engaging features which are easy to use, have strong hold down strength for the abutments that cooperate with the implant, and have precise anti-rotational features for the abutment. Dental implants, by their very nature, must be very small to fit into areas between close teeth. Wrench engaging features in dental implants generally fall into two categories, internal or external. Internal wrenching is convenient for placement, but generally lacks strength and accuracy for the mating abutment because they are substantially entirely within the threaded cavity. External wrenching implants have better accuracy, but are generally awkward to place.

The present invention is a dental implant which cooperates with both a driving wrench, for screwing the implant into the bony tissue, and a abutment which mounts onto the implant. It has a smoother, generally larger, diameter at the top and bone engaging ridges (threads) on a substantial part of the lower, exterior portion of the body. A raised shoulder area above the normal perimeter where a crown meets the implant allows for slots which pass through from the exterior of the raised shoulder area into the interior cavity of the implant to provide a stronger, more easily engagable wrenching method than is provided by either external only or internal only wrenching. The slots in the raised shoulder area further provide additional anti-rotational hold for a greater variety of abutments of the prosthesis to be attached to the anchor.

Accordingly, it is a principal object of the invention to provide a dental implant anchor which is compact in its overall length.

Another object of the invention is to provide a dental implant anchor that has the versatility to accept external or internal abutments.

Still another object of the invention is to provide a dental implant anchor that has stronger wrench engaging elements so it can be used in anterior regions where bone is narrowed.

It is yet another object of the invention to provide a dental implant anchor that has greater radial accuracy for abutments than standard internal wrenching implants.

It is again an object of the invention to provide a dental implant that has greater anti-rotational surface area than in standard implants.

Another object of the invention is to provide a dental implant that has a path for cement to escape to the outside diameter when cementable abutments are chose, thereby preventing hydraulic lock caused by cement being unable to escape from the cavity.

It is an object of the invention to provide improved elements and arrangements thereof in an apparatus for the purposes described which is dependable and fully effective in accomplishing its intended purposes.

Yet another object of the invention is to provide a dental implant anchor which has improved wrenching capabilities to ease installation into the bone.

Still another object of the invention is to provide a dental implant anchor which provides enhanced anti-rotational stability for the prosthesis attached to the anchor.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side elevational view of a first embodiment of the present invention.

FIG. 2 is a top plan view of the first embodiment of FIG. 1.

FIG. 3 is a front elevational view of a second embodiment of the present invention.

FIG. 4 is a top plan view of the second embodiment of FIG. 3.

FIG. 5 is a side elevational view of the second embodiment of FIG. 3.

### DETAILED DESCRIPTION OF THE PREFERRED EMBODIMENTS

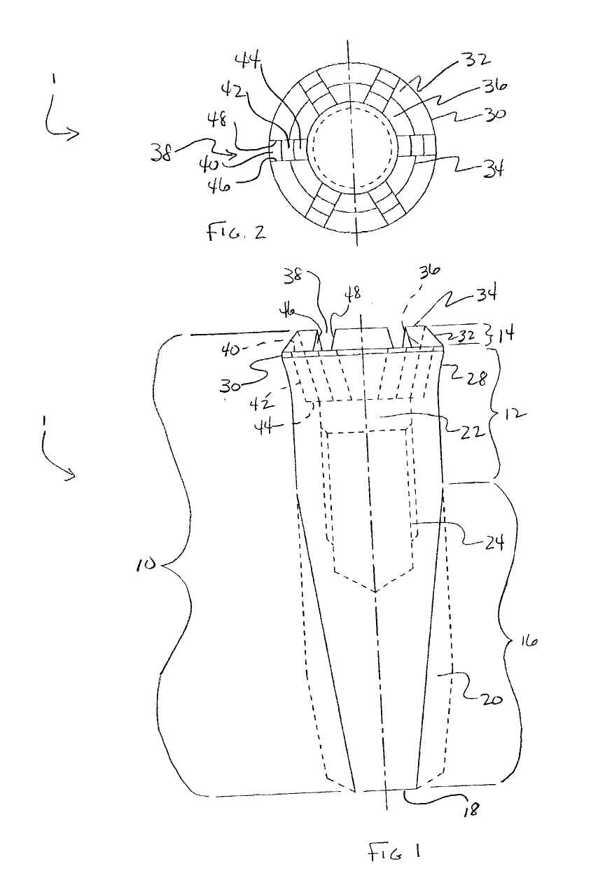

Referring first to FIGS. 1 and 2, a first embodiment of the dental implant anchor 1 has an elongate body 10 having a partially cylindrical, upper body portion 12 having a slightly roughened surface, a flared shoulder area 28 at its upper limit and a substantially cylindrical rim 30 having a nominal height, a raised area 14, and a lower body portion 16 tapering from cylindrical at its juncture with upper body portion 12 toward the longitudinal axis of body 10, terminating in a substantially flat insertion end 18.

Lower body portion 16 has helical, self tapping threads 20 (bone engaging ridges), which could be either continuous or broken, formed around its perimeter such that with each rotation of body 10, threads 20 cut into and engage fresh bone tissue to ensure a secure mating between threads 20 and bone tissue.

An internal cavity 22 is formed in upper body portion 12 and raised area 14, sharing a common longitudinal axis with body 10. While a substantially cylindrical cavity 22 is set forth for the purposes of disclosure, it would be evident to one skilled in the art that cavity 22 could be of any geometric shape. It would be further evident to one skilled in the art that internal cavity 22 could have a taper, either from its opening to its lower extreme or transitioning from a taper at its open end to substantially cylindrical at its lower end. Internal threads 24 are formed in the walls of cavity 22, threads 24 being adapted to receive a threaded post (not shown) of a post and core assembly.

Raised area 14 is formed by an inward taper 32 tapering toward the longitudinal axis of body 10 to an upper ridge 34. An interior taper 36 descends from upper ridge 34 at a slight angle, tapering from a wider diameter at upper ridge 34 to a lesser diameter at the upper edge of cavity 22 which descends interior of body 10, as described above.

A plurality of slots 38 are formed about the perimeter of shoulder 14 such that each slot 38 extends from the exterior of body 10, through raised area 14 to the interior of cavity 22. Each slot 38 has a horizontal slot surface 40 extending inwardly from the juncture of rim 30 and inward taper 32, an inner slot surface 42, descending from the inner edge of horizontal slot surface 40, and a ledge 44 extending from the base of inner slot surface 42 to the perimeter of cavity 22. Each slot further has a pair of side walls 46 and 48. Although a generally rectilinear shape has been described for each slot 38, a variety of other geometric shapes, including, but not limited to, triangular or “U” shaped, could used equally effectively.

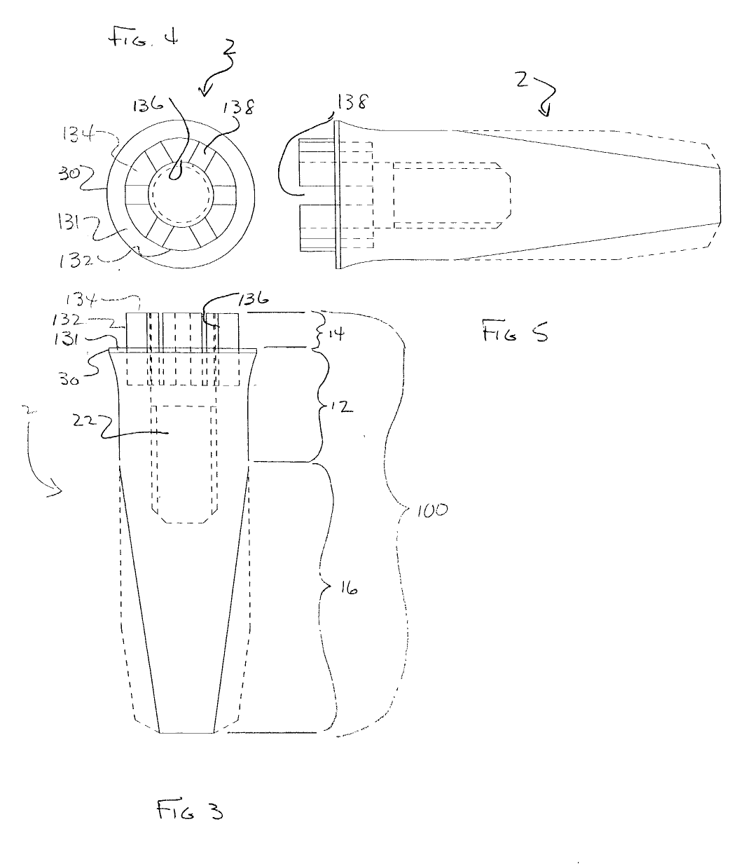

Referring now to FIGS. 3 thru 5 a second embodiment of dental implant anchor 100 is formed much the same as the first embodiment at FIGS. 1 and 2, with upper body portion 12 and lower body portion 16 being the same as in anchor 1. In the second embodiment 2, however, a horizontal ledge 131 extends inwardly from the perimeter of shoulder rim 30, substantially normal to the axis of body 10. A raised wall 132 rises from and substantially normal to horizontal ledge 131. An upper surface 134 extends inwardly from the upper edge of raised wall 132. An interior wall 136 descends from the inner edge of upper surface 134, interior wall 136 descending to form the wall of cavity 22. It would be evident to one skilled in the art that interior wall 136 could be tapered inwardly to the top of interior cavity 22.

A plurality of slots 138 are cut in raised area 14 such that they extend through raised area 14 from raised wall 132 to interior wall 136, descending the interior of raised area 14, terminating at a ledge 44, as in the preferred embodiment.

The slots 38 and 138 can provide both internal and external wrenching capability, as well as an additional anti-rotational element for holding a prosthesis steadily in place. Additionally, slots 38 and 138 allow a passage for excess glue to escape from cavity 22 as an abutment is seated, thereby preventing hydraulic lock within the cavity.

It is to be understood that the present invention is not limited to the embodiments described above, but encompasses any and all embodiments within the scope of the following claims.

What is claimed is:

1. A dental implant anchor for a dental prosthesis comprising a body having
a raised area,
a slightly roughened upper body portion,
a flared shoulder area,
a lower body portion having exterior bone engagement ridges for threading said anchor into bony tissue of a patients mouth,
receiving means for holding a prosthesis securely in said anchor, and
wrenching means for facilitating the threading of said anchor into said bony tissue, said wrenching means having at least one wrenching slot passing through said raised area into said receiving means.

2. A dental implant anchor for a dental prosthesis, as defined in claim 1, wherein said receiving means comprises an internal cavity within said upper body portion and said raised area, said cavity:
sharing a common longitudinal axis with said upper body portion and said raised area,
having walls tapering inwardly and downwardly from an upper ridge of said raised area and transitioning to substantially cylindrical, and
being internally threaded.

3. A dental implant anchor, as described in claim 1, wherein said wrenching means comprises a plurality of slots, said slots formed through said raised and into said cavity such that a wrench may engage said slots both externally from said anchor body and internally of said anchor body.

4. A dental implant anchor, as described in claim 3, wherein said slots of said wrenching means further engage slots in a prosthetic abutment to provide anti-rotational support for said prosthetic.

5. A dental implant anchor, as described in claim 1, wherein said bone engagement ridges are threads, said threads being one from the group of continuous, tapered helical threads and discontinuous, tapered helical threads.

6. A dental implant anchor for a dental prosthesis comprising a body having
a raised area,
a slightly roughened upper body portion,
a lower body portion having exterior bone engagement ridges for threading said anchor into bony tissue of a patients mouth,
receiving means for holding a prosthesis securely in said anchor, and
wrenching means for facilitating the threading of said anchor into said bony tissue, said wrenching means having at least one wrenching slot passing through said raised area into said receiving means.

7. A dental implant anchor for a dental prosthesis, as defined in claim 6, wherein said upper body portion further comprises a flared shoulder area proximate an upper end of said upper body portion.

8. A dental implant anchor for a dental prosthesis, as defined in claim 6, wherein said receiving means comprises an internal cavity within said upper body portion and said raised area, said cavity:
sharing a common longitudinal axis with said upper body portion and said raised area,
having walls tapering inwardly and downwardly from an upper ridge of said raised area and transitioning to substantially cylindrical, and
being internally threaded.

9. A dental implant anchor, as described in claim 6, wherein said wrenching means comprises a plurality of slots, said slots formed through said raised and into said cavity such that a wrench may engage said slots both externally from said anchor body and internally of said anchor body.

10. A dental implant anchor, as described in claim 9, wherein said slots of said wrenching means further engage slots in a prosthetic abutment to provide anti-rotational support for said prosthetic.

11. A dental implant anchor, as described in claim 6, wherein said bone engagement ridges are threads, said threads being one from the group of continuous, tapered, helical threads and discontinuous tapered, helical threads.

12. A dental implant anchor for a dental prosthesis comprising a body having
a raised area,
an upper body portion,
a lower body portion having exterior bone engagement ridges for threading said anchor into bony tissue of a patients mouth,
receiving means for holding a prosthesis securely in said anchor, and
wrenching means for facilitating the threading of said anchor into said bony tissue, said wrenching means having at least one wrenching slot passing through said raised area into the said receiving means.

13. A dental implant anchor for a dental prosthesis, as defined in claim 12, wherein said upper body portion has a slightly roughened surface.

14. A dental implant anchor for a dental prosthesis, as defined in claim 12, wherein said upper body portion further comprises a flared shoulder area proximate an upper end of said upper body portion.

15. A dental implant anchor for a dental prosthesis, as defined in claim 12, wherein said receiving means comprises an internal cavity within said upper body portion and said raised area, said cavity:
sharing a common longitudinal axis with said upper body portion and said raised area,
having walls tapering inwardly and downwardly from said raised area and transitioning to substantially cylindrical.

16. A dental implant anchor, as described in claim 12, wherein said internal cavity further comprises internal threads.

17. A dental implant anchor, as described in claim 12, wherein said wrenching means comprises a plurality of slots, said slots formed through said raised and into said cavity such that a wrench may engage said slots both externally from said anchor body and internally of said anchor body.

18. A dental implant anchor, as described in claim 17, wherein said slots of said wrenching means further engage slots in a prosthetic abutment to provide anti-rotational support for said prosthetic.

19. A dental implant anchor, as described in claim 12, wherein said bone engagement ridges are threads, said threads being one from the group of continuous, tapered helical threads and discontinuous, tapered helical threads.
